(19) United States
(12) Patent Application Publication
(10) Pub. No.: US 2010/0226022 A1
(43) Pub. Date: Sep. 9, 2010

(54) FRESNEL LENS, THE APPARATUS AND THE METHOD OF MANUFACTURING THEREOF

(75) Inventors: Wei Shen, Changhua Hsien (TW); Yuan-Lin Lee, Changhua Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: GLORY SCIENCE CO., LTD., Changhua Hsien (TW)

(21) Appl. No.: 12/398,474

(22) Filed: Mar. 5, 2009

(51) Int. Cl. G02B 3/08; B29D 11/00

(52) U.S. Cl. 359/742; 264/1.7; 425/470

(57) ABSTRACT

A Fresnel lens includes a plate made of a glass material and Fresnel portions made of plastic material and integrally formed onto the plate. A method of manufacturing the Fresnel lens includes the steps of adding the plastic material in a forming apparatus, curing the plastic material, and then separating the forming apparatus and the plate from each other to form the Fresnel lens. An apparatus for manufacturing the Fresnel lens includes a forming apparatus coupling with the plate of the Fresnel lens, and a forming concave with inversion corresponding to the shape of the forming Fresnel portions. The forming concave shapes the plastic material into the Fresnel portion. Therefore, the Fresnel lens takes lower manufacture cost than the glass Fresnel lens and has better reliability than the plastic Fresnel lens while exposing in high temperature and high light density.

### BACKGROUND OF THE INVENTION

1. Field of the Invention

The present invention relates to a lens and, more particularly, to a Fresnel lens, the apparatus and the method of manufacturing thereof.

2. The Related Art

Please refer to FIG. 15. A common Fresnel lens 8 functions as condensing light as a spherical lens 9. However, the weight and size of the common Fresnel lens 8 are smaller than the spherical lens 9. Therefore, the common Fresnel lens 8 has replaced the spherical lens 9 in many fields.

Generally, the common Fresnel lens 8 is applied to an apparatus which needs a thinner and lighter lens, such as a light projector used in lighthouse, an overhead projector, a portable magnifier, etc. The common Fresnel lens 8 is generally made of glass material or plastic material for adapting to different environments.

The thermal reliability of glass Fresnel lens is better than the plastic Fresnel lens, which is necessary for lens applied in critical environments with high temperature and high light density, such as an outdoor place. The glass Fresnel lens is generally manufactured by assembling pieces of grinding glass lenses or directly molding glass material. Because both the rigidity and the melting point of glass are high, the manufacturing procedure is complex.

Therefore, the manufacturing cost of a glass Fresnel lens is high and limits the size of a glass Fresnel lens. Nowadays a small glass Fresnel lens is manufactured by molding the glass material and a large glass Fresnel lens is made up of small glasses lenses.

The plastic Fresnel lens is generally manufactured by molding, impressing, or injection process. Although the cost and the weight of the plastic Fresnel lens are less than those of the glass Fresnel lens, because of its worse thermal reliability, most of the plastic Fresnel lenses are adapting to low temperature environments and low light density environments, such as an indoor space.

The Fresnel lens is also applied to a solar energy system as a condenser to focus sunlight on small solar cells. In such a light enhancement apparatus, a large glass Fresnel lens becomes one of the necessary components which can provide enough high thermal and high light density reliability. However, the complicated manufacturing procedure results in high cost of a large glass Fresnel lens.

### SUMMARY OF THE INVENTION

A first object of the present invention is to provide a Fresnel lens having advantages of the lower manufacture cost and high reliability while exposing in high temperature and high light density.

According to the invention, the Fresnel lens has a base plate and a Fresnel portion. The base plate is made of a glass material. The Fresnel portion is made of a plastic material and integrated onto a surface of the base plate. Since, the Fresnel lens has advantages of the lower manufacture cost than the glass Fresnel lens and better reliability than the plastic Fresnel lens.

A second object of the present invention is to provide a method of manufacturing the Fresnel lens. According to the invention, the method includes the following steps. In step 1, the plastic material is added into a forming apparatus, and then the plastic material is adhered onto the surface of the base plate. In step 2, the plastic material is cured to solidification to form the Fresnel portion integrated onto the surface of the base plate. In step 3, the base plate and the forming apparatus are separated from each other.

A third object of the present invention is to provide an apparatus for manufacturing the Fresnel lens. According to the present invention, the apparatus has a forming apparatus and a forming concave. The forming apparatus is coupled onto the base plate for receiving the plastic material. The forming concave shapes the plastic material in the Fresnel portion integrated onto the base plate. The shape of the forming concave mates the shape of the Fresnel portion.

The base plate is made of glass material. The Fresnel portion is made of the plastic material received in the forming apparatus and shaped by the forming concave, which is integrated onto the surface of the base plate. Because a glass material constructs the main body of the Fresnel lens and a thin plastic material forms the optical Fresnel portion, such a Fresnel lens has advantages of the lower manufacture cost than the glass Fresnel lens and better reliability than the plastic Fresnel lens.

### BRIEF DESCRIPTION OF THE DRAWINGS

The present invention will be apparent to those skilled in the art by reading the following description of preferred embodiments thereof, with reference to the attached drawings, in which:

FIG. 1 is a section view showing a Fresnel lens;

FIG. 2 is a flow chart showing a first method of manufacturing the Fresnel lens according to the present invention;

FIG. 3 is a flow chart showing steps of the first method of manufacturing the Fresnel lens according to the present invention;

FIG. 4 is a flow chart showing a second method of manufacturing the Fresnel lens according to the present invention;

FIG. 5 is a flow chart showing steps of the second method of manufacturing the Fresnel lens according to the present invention;

FIG. 6 is a flow chart showing a third method of manufacturing the Fresnel lens according to the present invention;

FIG. 7 is a flow chart showing steps of the third method of manufacturing the Fresnel lens according to the present invention;

FIG. 8 shows a second mold according to the present invention;

FIG. 9 is a flow chart showing a fourth method of manufacturing the Fresnel lens according to the present invention;

FIG. 10 is a flow chart showing steps of the fourth method of manufacturing the Fresnel lens according to the present invention;

FIG. 11 shows a first forming plate according to the present invention;

FIG. 12 is a partial enlarged view showing a tip of a concave portion of the first forming plate according to the present invention;

FIG. 13 shows a second forming plate according to the present invention;

FIG. 14 is a partial enlarged view showing a tip of a concave portion of the second forming plate according to the present invention; and

FIG. 15 shows a section view of a common Fresnel lens and a section view of a spherical lens.

### DETAILED DESCRIPTION OF THE PREFERRED EMBODIMENT

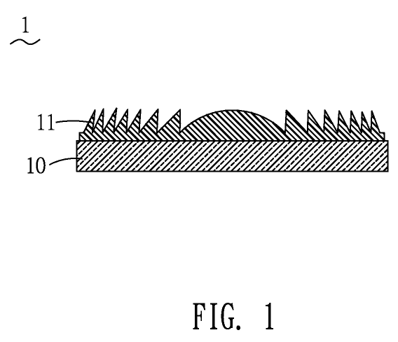

Please refer to FIG. 1, showing a preferred embodiment of a Fresnel lens 1. The Fresnel lens 1 has a base plate 10 and a Fresnel portion 11. The base plate 10 is made of a glass material. The Fresnel portion 11 is made of a plastic material and integrated onto a surface of the base plate 10. Specially, the thickness of the Fresnel portion 11 is less than 2.5 millimeters.

For the purpose of easily manufacturing the Fresnel lens 1 in this invention, the main portion of the Fresnel lens 1 being the glass base plate 10, and the remainder portion of Fresnel lens 1 being the plastic Fresnel portion 11 are required. A small size Fresnel lens and a middle size Fresnel lens can be directly manufactured by integrating a plastic Fresnel portion 11 onto a surface of the glass base plate 10. A large size Fresnel lens can be made up of many small size Fresnel lens. Therefore, the Fresnel lens 1 has the advantages of both high thermal reliability and low cost.

Specially, the base plate 10 of the Fresnel lens 1 may be any type of a plane plate, a wedge-shaped plate, a convex plate and a concave plate. The plastic material may be a thermosetting plastic such as a silicone, or an ultraviolet curing plastic such as an epoxy resin or an acrylic resin. The plastic material is formed to Fresnel portion 11 by a forming concave of a forming apparatus and then cured to solidification by heating up or radiating ultraviolet.

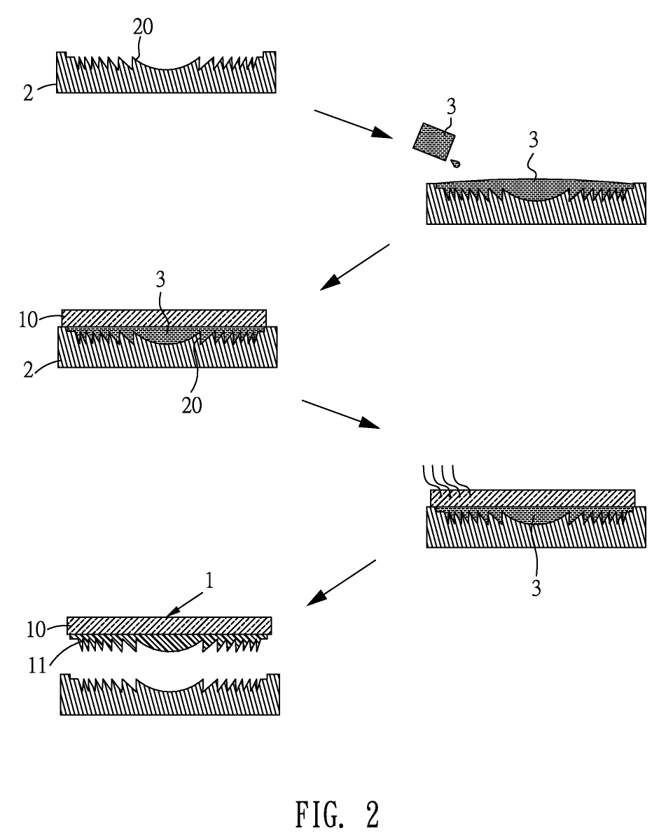

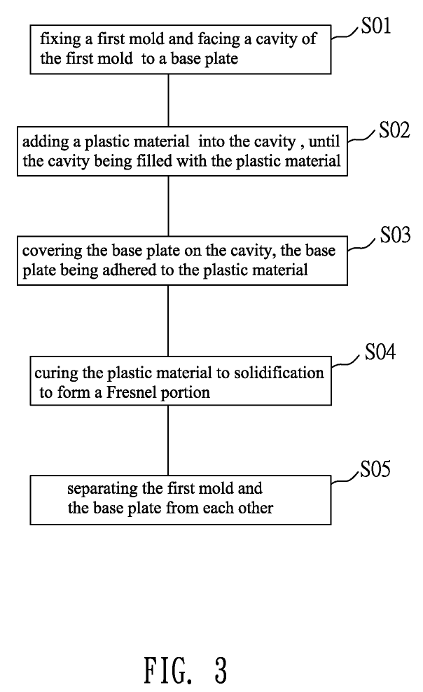

Please refer to FIG. 2 and FIG. 3. FIG. 2 is a flow chart of a first method of manufacturing the Fresnel lens 1. FIG. 3 is a flow chart showing steps of the first method of manufacturing the Fresnel lens 1. In this embodiment, the forming apparatus is a first mold 2 and the forming concave is a cavity 20 of the first mold 2. The method of manufacturing the Fresnel lens 1 includes the following steps. The shape of the cavity 20 of the first mold 2 is mating with the shape of the Fresnel portion 11.

In S01, the first mold 2 is fixed and the cavity 20 is facing the base plate 10. In S02, the plastic material 3 is added into the cavity 20 by a nozzle, until the cavity 20 is filled up with the plastic material 3. In S03, the base plate 10 is covered on the cavity 20 for being adhered to cure the plastic material 3. In S04, the plastic material 3 is cured to solidification to form the Fresnel portion 11. In S05, the first mold 2 and the base plate 10 are separated from each other. Therefore, the base plate 10 is integrated with the Fresnel portion 11 to form the Fresnel lens 1.

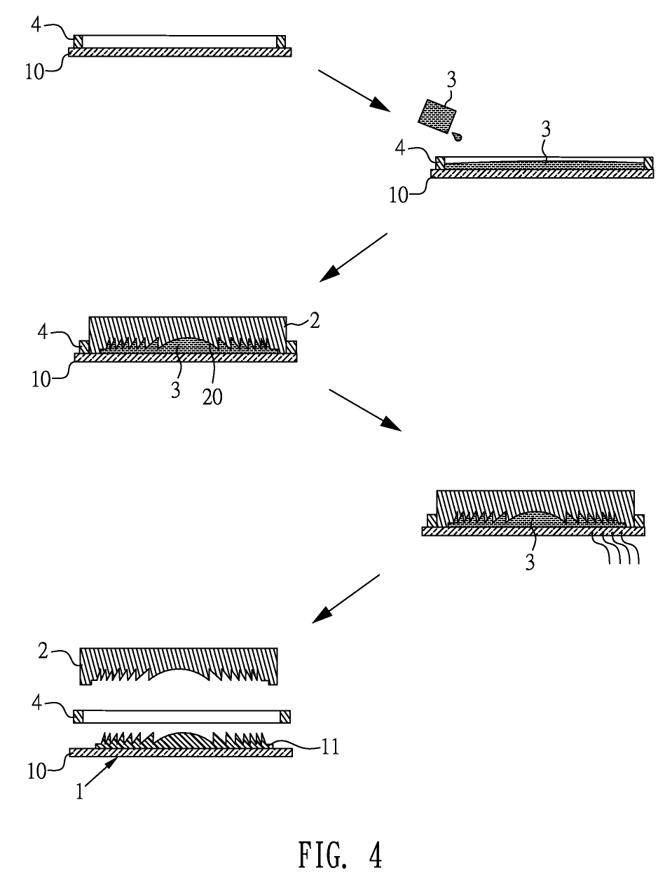

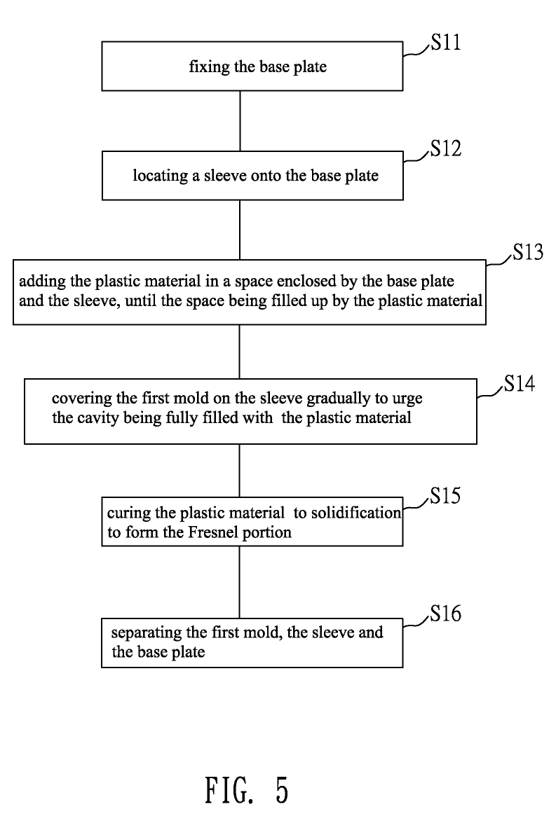

Please refer to FIG. 4 and FIG. 5. FIG. 4 is a flow chart of a second method of manufacturing the Fresnel lens 1. FIG. 5 is a flow chart showing the steps of the second method of manufacturing the Fresnel lens 1. In this embodiment, the forming apparatus is the first mold 2 and a sleeve 4. The forming concave is the cavity 20 of the first mold 2. The method of manufacturing the Fresnel lens 1 includes the following steps.

In S11, the base plate 10 is fixed. In S12, the sleeve 4 is located onto the base plate 10. In S13, the plastic material 3 is added onto the space enclosed by base plate 10 and the sleeve 4 until filled up. In S14, the first mold 2 having the cavity 20 faces to the sleeve 4, and then covers on the sleeve 4 gradually. Since, the cavity 20 of the first mold 2 is fully filled with the plastic material 3.

In S15, the plastic material 3 is cured to solidification for forming the Fresnel portion 11. In S16, the first mold 2, the sleeve 4 and the base plate 10 are separated respectively. Therefore, the base plate 10 can be integrated with the Fresnel portion 11 to form the Fresnel lens 1. In this embodiment, the dimension of the sleeve 4 and the dimension of the cavity 20 of the first mold 2 are mating with the dimension of the Fresnel portion 11 of the Fresnel lens 1.

In the first method and the second method, if the plastic material 3 is the thermosetting plastic, then heating up the plastic material 3 will be preferable in the curing step. If the plastic material 3 is ultraviolet curing plastic, then radiating ultraviolet to the plastic material 3 will be preferable in the curing step. Besides, the manufacturing method can be implemented in a vacuum room to prevent from forming air bubbles between the base plate 10 and the plastic material 3 while the plastic material adheres to the base plate 10.

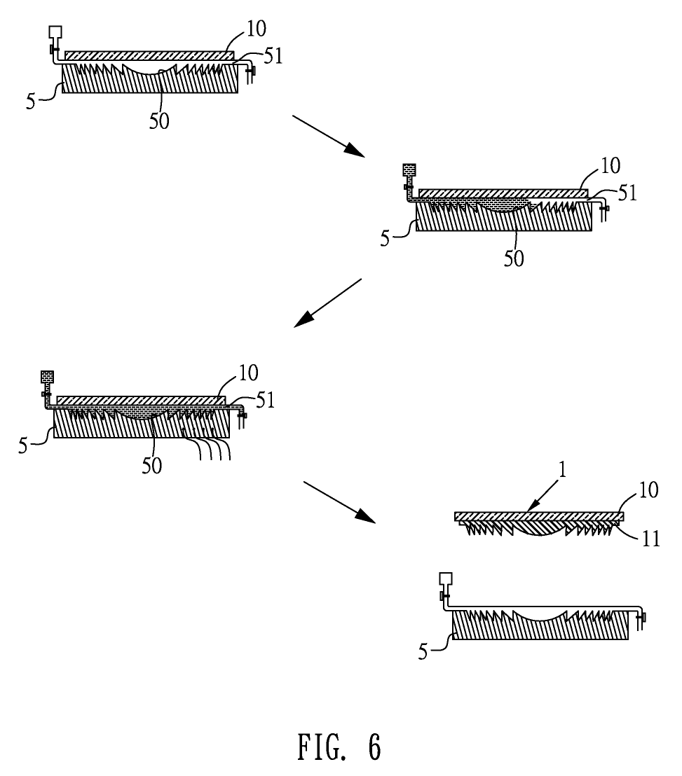

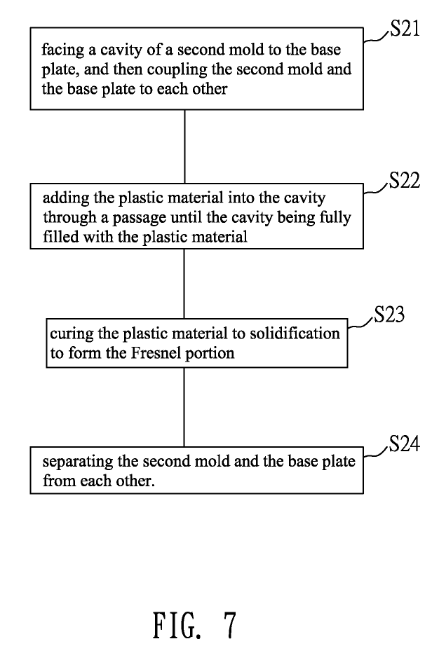

Please refer to FIG. 6 to FIG. 8. FIG. 6 is a flow chart of a third method of manufacturing the Fresnel lens 1. FIG. 7 is a flow chart showing the steps of the third method of manufacturing the Fresnel lens 1. FIG. 8 shows a second mold 5 having a cavity 50 and a passage 51 connected to the cavity 50 from the outside. In this embodiment, the forming apparatus is the second mold 5 with the forming cavity 50. The method of manufacturing the Fresnel lens 1 includes the following steps.

In S21, the second mold 5 having the cavity 50 is faced to the base plate 10, and then the second mold 5 and the base plate 10 are coupled to each other. Therefore, the second mold 5 becomes a closed space. In S22, the plastic material 3 is added into the second mold 5 through the passage 51 until the second mold 5 is fully filled with the plastic material 3.

In S23, the plastic material 3 is cured to solidification to form the Fresnel portion 11. In S24, the second mold 5 and the base plate 10 are separated from each other. Therefore, the base plate 10 is integrated with the Fresnel portion 11 to form the Fresnel lens 1. In this embodiment, the plastic material 3 can be injected into the cavity 50 by injecting pressure, or sucked into the cavity 50 by vacuum attraction

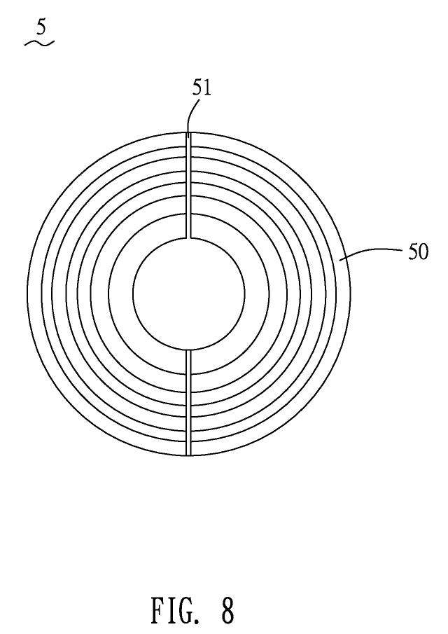

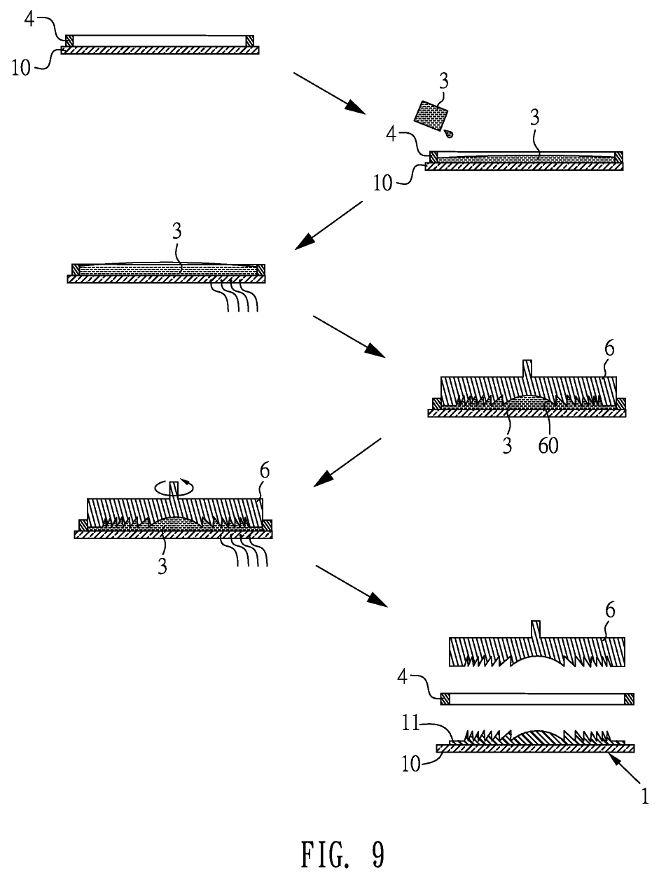

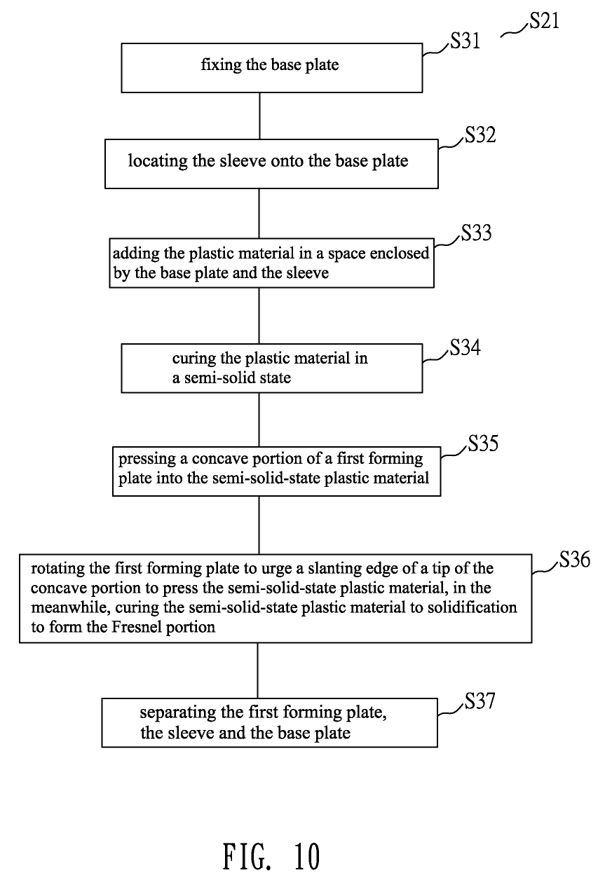

Please refer to FIG. 9 to FIG. 12. FIG. 9 is a flow chart of a fourth method of manufacturing the Fresnel lens 1. FIG. 10 is a flow chart showing the steps of the fourth method of manufacturing the Fresnel lens 1. FIG. 11 shows a first forming plate 6. FIG. 12 is a partial enlarged view showing a tip 61 of a concave portion 60 of the first forming plate 6. In this embodiment, the forming apparatus is the sleeve 4 and the first forming plate 6. The forming concave is the concave portion 60.

The first forming plate 6 is of a rectangle shape. A long edge of the first forming plate 6 is cut in the concave portion 60. A shape of the concave portion 60 is mating with a cross-section-shape of the Fresnel portion 11 of the Fresnel lens. The tip 61 of the concave portion 60 is cut in a slanting edge 62. The length of the concave portion 60 equals to the diameter of the Fresnel portion 11 of the Fresnel lens 1. The method of manufacturing the Fresnel lens 1 includes the following steps.

In S31, the base plate 10 is fixed. In S32, the sleeve 4 is located onto the base plate 10. In S33, the plastic material 3 is added onto the space enclosed by the base plate 10 and the sleeve 4. In S34, the plastic material 3 is cured in a semi-solid state. In S35, the concave portion 60 of the first forming plate 6 is pressed into the semi-solid-state plastic material 3. In S36, the first forming plate 6 is rotated to urge the slanting edge 62 of the tip 61 of the concave portion 60 to press the semi-solid-state plastic material 3. In the meanwhile, the semi-solid-state plastic material 3 is cured to solidification to form the Fresnel portion 11. In S37, the first forming plate 6, the sleeve 4 and the base plate 10 are separated. Finally, the base plate 10 is integrated with the Fresnel portion 11 to form the Fresnel lens 1.

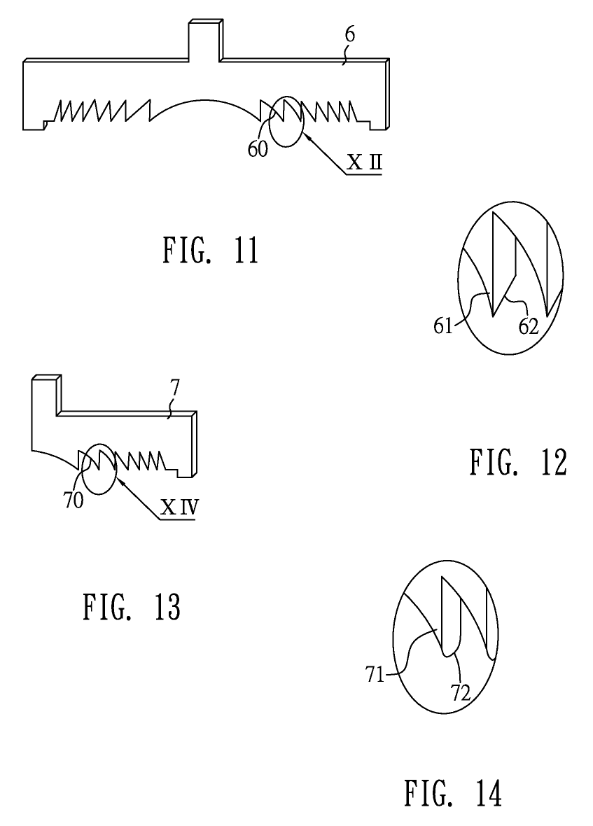

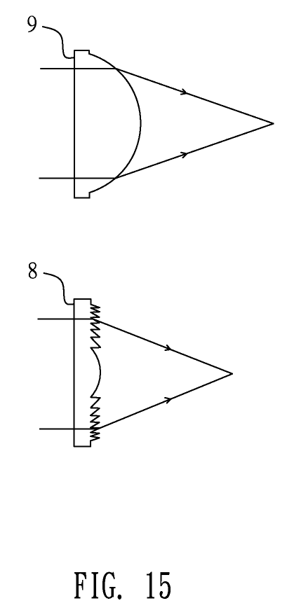

Please refer to FIG. 13 and FIG. 14. FIG. 13 shows a second forming plate 7. FIG. 14 is a partial enlarged view showing a tip 71 of a concave portion 70 of the second forming plate 7. Furthermore, the first forming plate 6 can be replaced by the second forming plate 7. The second forming plate 7 is of a rectangle shape. A long edge of the second forming plate 7 is cut in the concave portion 70. A shape of the concave portion 70 is mating with a half cross-section-shape of the Fresnel portion 11 of the Fresnel lens 1. The tip 71 of the concave portion 70 is cut in an arc-shaped edge 72. The length of the concave portion 70 equals to the radius of the Fresnel portion 11 of the Fresnel lens 1.

While the second forming plate 7 is rotated, the arc-shaped edge 72 of the tip 71 of the concave portion 70 is urged to press the semi-solid-state plastic material 3.

As described above, the base plate 10 is integrated with the Fresnel portion, formed by the forming apparatus such as the mold, the sleeve and the forming plate, to form the Fresnel lens 1. For the purpose of easily manufacture the Fresnel lens, a glass base plate 10 being the main portion of the Fresnel lens 1, and the plastic Fresnel portion 11 being the remainder portion of Fresnel lens 1 directly integrated onto the glass base plate 10 are required.

The small size Fresnel lens and the middle size Fresnel lens can be directly manufactured by forming the plastic Fresnel portion 11 integrated onto the surface of the glass base plate 10. The large size Fresnel lens can be made up of many small size Fresnel lens. Therefore, the Fresnel lens takes lower manufacture cost than the glass Fresnel lens and has better reliability than the plastic Fresnel lens while exposing in high temperature and high light intensity

The Fresnel lens 1 adapts to be applied to the light enhancement apparatus of the solar energy system. The Fresnel lens 1 can condense light on a solar cell to urge the solar cell to absorb as much solar energy as of which with the far larger dimension lens does. Since the Fresnel lens 1 can cooperate with the high efficiency solar cell for providing much power.

The Fresnel lens 1 can also be applied to a heat absorbing pipe. The Fresnel lens 1 can condense light on the heat absorbing pipe to urge it to absorb as much solar energy as of which with the far larger dimension lens does. Since the heat absorbing pipe can heat up the liquid therein, it can be applied to a water heating system, a radiator, and a thermal electric apparatus, etc.

Furthermore, the present invention is not limited to the embodiments described above; various additions, alterations and the like may be made within the scope of the present invention by a person skilled in the art. For example, respective embodiments may be appropriately combined.

What is claimed is:

1. A Fresnel lens, comprising:
a glass base plate; and
a Fresnel portion made of a plastic material and integrated onto a surface of said base plate.

2. The Fresnel lens as claimed in claim 1, wherein a thickness of said Fresnel portion is smaller than 2.5 millimeters.

3. The Fresnel lens as claimed in claim 1, wherein said plastic material is one of a thermosetting plastic and an ultraviolet curing plastic.

4. A method of manufacturing a Fresnel lens, comprising:
adding a plastic material into a forming apparatus to make said plastic material adhere onto the surface of the glass base plate;
curing said plastic material to solidification to form a Fresnel portion integrated onto said surface of the glass base plate;
separating the glass base plate and said forming apparatus from each other.

5. The method of manufacturing a Fresnel lens as claimed in claim 4, wherein said forming apparatus is a mold having a cavity of which a shape is with respect to said Fresnel portion, a step of adding said plastic further comprises:
adding said plastic material into said mold until fully filled with said plastic material; and
covering the glass base plate onto said cavity to urge said plastic material being adhered onto said surface of the glass base plate.

6. The method of manufacturing a Fresnel lens as claimed in claim 5, wherein said plastic material is dripped into said mold, a step of adhering said plastic material onto said surface of said glass base plate is implemented in a vacuum room.

7. The method of manufacturing a Fresnel lens as claimed in claim 4, wherein said forming apparatus comprises a mold and a sleeve, said mold has a cavity of which a shape is with respect to said Fresnel portion, a step of adding said plastic material further comprises:
locating said sleeve onto said surface of said glass base plate;
adding said plastic material onto the space enclosed by said glass base plate and said sleeve until fully filled with said plastic material;
facing said mold to said sleeve and aligning said mold with said sleeve; and
covering said mold onto said sleeve gradually to urge said cavity is fully filled with said plastic material.

8. The method of manufacturing a Fresnel lens as claimed in claim 7, wherein said plastic material is dripped into said cavity, the step of adhering said plastic material onto said surface of said glass base plate is implemented in a vacuum room.

9. The method of manufacturing a Fresnel lens as claimed in claim 4, wherein said forming apparatus is a mold having a cavity of which a shape is with respect to said Fresnel portion and a passage connecting said cavity to the outside, a step of adding said plastic material further comprises:
facing said mold to said glass base plate, and then coupling said mold and said glass base plate to each other to ensure said cavity becomes a closed space;
adding said plastic material into said cavity through said passage until said cavity is fully filled with said plastic material.

10. The method of manufacturing a Fresnel lens as claimed in claim 9, wherein a step of adding said plastic material into said cavity is implemented by one of an injecting pressure and vacuum attraction.

11. The method of manufacturing a Fresnel lens as claimed in claim 4, wherein said forming apparatus comprises a sleeve and a forming plate, an edge of said forming plate is cut a concave portion of which shape is with respect to a cross-section-shape of said Fresnel portion, a step of adding said plastic material further comprises:
locating said sleeve onto said glass base plate; and
adding said plastic material onto a space enclosed by said glass base plate and said sleeve,
a step of curing said plastic material further comprises:
curing said plastic material in a semi-solid state;
pressing said concave portion of said forming plate into said semi-solid-state plastic material; and
rotating said forming plate to urge said concave portion to press said semi-solid-state plastic material, in the meanwhile, curing said semi-solid-state plastic material to solidification to form said Fresnel portion.

12. An apparatus for manufacturing a Fresnel lens, comprising:
a forming apparatus coupling to a glass base plate of said Fresnel lens; and
a forming concave forming a plastic material in a Fresnel portion integrated onto said glass base plate of said Fresnel lens, a shape of said forming concave is with respect to said Fresnel portion.

13. The apparatus for manufacturing a Fresnel lens as claimed in claim 12, wherein said forming apparatus is a mold, said forming concave is a cavity of said mold for receiving said plastic material.

14. The apparatus for manufacturing a Fresnel lens as claimed in claim 12, wherein said forming apparatus has a sleeve located onto said glass base plate, of which a diameter equals to said Fresnel portion, said forming concave is a cavity of said mold, the dimension of said cavity is with respect to said Fresnel portion, said plastic material is fully filled with the space enclosed by said glass base plate, said sleeve and said cavity of said mold.

15. The apparatus for manufacturing a Fresnel lens as claimed in claim 12, wherein said forming apparatus is a mold, said forming concave is a cavity of said mold, said mold has a passage connected to said cavity from the outside, said plastic material is fully filled with a closed space defined by said glass base plate and said cavity of said mold.

16. The apparatus for manufacturing a Fresnel lens as claimed in claim 12, wherein said forming apparatus has a sleeve for receiving said plastic material, and a forming plate, said sleeve is located onto said glass base plate, of which the diameter equals to said Fresnel portion, said forming concave is a concave portion cut in an edge of said forming plate, said concave portion of said forming plate is pressed into said plastic material, while said forming plate is rotating, said concave portion presses said plastic material to form said Fresnel portion.

17. The apparatus for manufacturing a Fresnel lens as claimed in claim 16, wherein said forming plate is of a rectangle shape, said concave portion is cut in a long edge of said forming plate, the shape of said concave portion is mated with the cross-section-shape of said Fresnel portion, the length of said concave portion equals to the diameter of said Fresnel portion.

18. The apparatus for manufacturing a Fresnel lens as claimed in claim 16, wherein said forming plate is of a rectangle shape, the shape of said concave portion is mated with the half cross-section-shape of said Fresnel portion, the length of said concave portion equals to the radius of said Fresnel portion.

19. The apparatus for manufacturing a Fresnel lens as claimed in claim 16, wherein a tip of said concave portion is cut in a slanting edge.

20. The apparatus for manufacturing a Fresnel lens as claimed in claim 16, wherein a tip of said concave portion is cut in an arc-shaped edge.
